(19) United States
(12) Patent Application Publication
(10) Pub. No.: US 2024/0186558 A1
(43) Pub. Date: Jun. 6, 2024

(54) CONVECTION BATTERY SYSTEM AND PROCESS

(71) Applicant: Baisheng ZOU, Spring, TX (US)

(72) Inventor: Baisheng ZOU, Spring, TX (US)

(21) Appl. No.: 18/526,314

(22) Filed: Dec. 1, 2023

Related U.S. Application Data
(60) Provisional application No. 63/385,831, filed on Dec. 2, 2022.

(51) Int. Cl. H01M 10/04; H01M 10/42

(52) U.S. Cl. CPC H01M 10/0413; H01M 10/4214; H01M 10/4235; H01M 10/0525; H01M 2220/20

(57) ABSTRACT

Disclosed is a convection battery system process for large power storage units or electrical vehicles that allows easy electrolyte flow through electrodes and other components by novel designs of a separator, an anode and a cathode. Utilization of dendrite-stopping chambers and reverse electrolyte flow minimize dendrite formation in metal anodes. The system and process allow significant increase of size and power output of an individual battery electrode, minimizing the total number of electrodes required in a power system, and increasing overall performances of a battery pack with hundreds of electrodes.

### RELATED U.S. APPLICATIONS

The present application claims priority from U.S. Provisional Application No. 63/385,831, filed on Dec. 2, 2022.

### FIELD OF THE INVENTION

The present invention relates to the field of lithium-ion battery systems. More particularly, the present invention relates to convection battery systems and methods. Even more particularly, present invention relates to convection battery systems and methods which utilize dendrite stopping chambers and reverse flow to minimize dendrite formation.

### BACKGROUND OF THE INVENTION

An electric vehicle uses thousands of lithium ion battery cells that are connected together. For example, Tesla automobiles use from 2976 to 8256 individual battery cells, and the exact number depends on the model selected. The reason for requiring so many cells is that a lithium-ion battery cell has size and power limitations.

The size and power limitations of an individual lithium battery cell are caused by various mass and heat transfer issues. A thick battery would face lithium-ion mass transfer rate limitation and heat dissipation limitation.

Another issue with lithium-ion batteries is lithium dendrite formation at a lithium metal anode. During charging and discharging cycles, a lithium metal anode forms fiber-like dendrites, which grow in the direction of cathode, eventually reaching the cathode and causing a short circuit between the anode and cathode. The commercial solution to this problem is intercalation of lithium ions within carbon graphite. The carbon graphite anode, used in lithium-ion batteries, solves the dendrite problem at the cost of energy density. A lithium-ion battery has 1/10 the energy density of a lithium metal battery.

Unlike batteries for cell phones and other electronics, batteries for vehicles and large power storage units are not limited to stationary cell designs. Dynamic cell designs that utilize various chemical processing methods and unit operations could be used. The most obvious improvement with a dynamic cell design is forced convection flow using a pump.

In a traditional static battery, ions in electrolyte solution are transferred by two processes: one is diffusion, and the other is electrophoresis. It is common knowledge that bulk flow (convection) is faster than diffusion and electrophoresis. By utilizing a pump to push liquid through electrodes, three advantages could be achieved: the first is that ion transport becomes faster, second is that the anode and cathode do not need to be close to each other as in a stationary lithium battery, and the third is that electrode size can be increased since the diffusional limitation is removed.

U.S. Pat. No. 8,911,893 and US Pat Publication 20220123377 have both proposed convection battery operation and methods of electrode fabrication for such a battery.

It is an objective of the present invention to provide a convection battery system having improved electrode and separator designs that greatly reduce flow resistance and increase flow rate through the system.

Another objective of the invention is to increase individual battery cell size and power storage, and reduce the total number of cells used in an electrical vehicle or in a power storage unit.

Another objective of the present invention is to provide systems and methods for dendrite minimization in a convection battery system through dendrite stopper chambers and reverse flow operations.

These and other objectives and advantages will become apparent from a reading of the attached specification and appended claims.

### BRIEF SUMMARY OF THE INVENTION

In an embodiment, the present invention is a convection battery system including a plurality of anodes and cathodes. The plurality of anodes and cathodes are in fluid connection with each other and are alternately arranged in a loop formation. A pump is positioned along the loop formation and is adapted to flow electrolyte fluid between the plurality of anodes and cathodes. A plurality of dendrite-stopping chambers are in fluid communication with the anodes and cathodes. The dendrite-stopping chambers preferably have a bare-metal fibrous media therein, and each of the chambers has a diode connected thereto. The diode is arranged to allow electrons to exit the dendrite-stopping chamber.

Preferably, the plurality of anodes and cathodes include a first cathode electrically connected to a first anode and two diodes of dendrite-stopping chambers positioned on each side of the first anode. A second anode is in fluid communication with the first cathode and is positioned on an opposite side of the first cathode from the first anode. In a discharging process of the system, electrons move from the first anode toward the first cathode, and electrolyte fluid is pumped and flows in a first direction, such that lithium ions move from the second anode to the first cathode.

In an embodiment, the system further includes a plurality of dynamic separators in fluid communication with the plurality of anodes and cathodes. Each of the dynamic separators includes a flow passageway and an electrically-insulating separator plate which closes the flow passageway when flow of electrolyte fluid from the pump ceases.

In an embodiment, the dendrite stopping chambers have a smaller volume than chambers associated with the anodes of the convection battery system.

In an embodiment, a fluid cooler is provided in the loop formation with the anodes and cathodes.

The present invention is also a convection battery process including fluidly connecting a plurality of anodes and cathodes in an alternating loop arrangement. An electrolyte fluid is then flowed in a first direction between the plurality of anodes and cathodes. An anode and a cathode of the plurality of anodes and cathodes are electrically connected together, wherein the cathode is upstream of the anode with regard to the first direction of the flow of electrolyte fluid. A load is then applied to the system between the connected anode and cathode of the plurality of anodes and cathodes, such that electrons flow from the anode toward the cathode in the direction opposite the first direction of the flowed electrolyte fluid.

In an embodiment of the process of the present invention, the electrolyte fluid flow is reversed and flowed in a second direction. In this embodiment, the electrical connections are altered such that the cathode is upstream of the anode with regard to the second direction of the flow of electrolyte fluid.

In an embodiment, an electrolyte flow direction and an electron flow direction can be reversed simultaneously, whereby alternating flow directions of electrolyte and electrons prevents dendrite formation and growth of a significant scale on either side of an anode of the plurality of anodes.

The present invention is also a static battery construction including a dendrite-stopping layer positioned between a first membrane separator and a second membrane separator; an anode positioned exterior of said first membrane separator; and a cathode positioned exterior of said second membrane separator. The dendrite stopping layer is connected via a wire to a diode which is adapted to only allows electrons to flow outwardly and toward the cathode during battery discharge. Active metal and dendrites in the dendrite-stopping layer will dissolve during a discharge process, and active metal cannot grow during a charging process due to the diode not allowing electrons to flow into the dendrite-stopping layer.

This foregoing Section is intended to describe, with particularity, the preferred embodiments of the present invention. It is understood that modifications to these preferred embodiments can be made within the scope of the present claims. This Section should not to be construed, in any way, as limiting of the broad scope of the present invention. The present invention should only be limited by the following claims and their legal equivalents.

### BRIEF DESCRIPTION OF THE DRAWINGS

FIG. 1 is a diagram illustrating the discharging process of the convection battery system in accordance with the preferred embodiment of the present invention.

FIG. 2 is a diagram illustrating the charging process of the convection battery system of the preferred embodiment of the present invention.

FIG. 3 is a diagram illustrating the discharging process of the convection battery system in accordance with the present invention, wherein the flow of electrolyte fluid has been reversed.

FIG. 4 illustrates the dynamic separator of the present invention in closed and open states.

FIG. 5 illustrates a traditional static battery having a dendrite-stopper of the present invention installed therein.

FIG. 6 illustrates the traditional static battery having a dendrite-stopper of the present invention installed therein, wherein the battery is in a charging state.

### DETAILED DESCRIPTION OF THE INVENTION

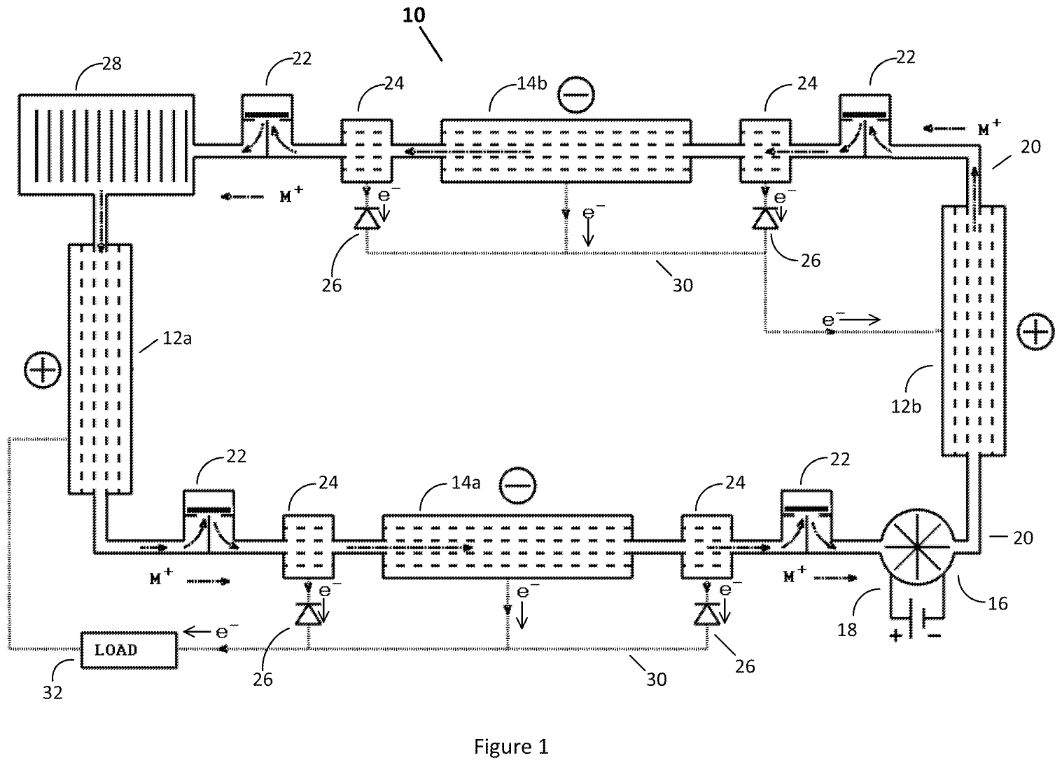

Referring to FIG. 1, there is shown the convection battery system 10 accordance with for an embodiment of the present invention. FIG. 1 illustrates the discharging process for operation of the system 10. As can be seen in FIG. 1, the convection battery system 10 includes a plurality of cathodes 12a and 12b connected in fluid communication with a plurality of anodes 14a and 14b (collectively, the electrodes). Within the concept of the present invention, there can be a greater or lesser number of anodes and cathodes. However, importantly, the electrodes are arranged in a loop configuration and alternate between anodes and cathodes. The plurality of cathodes and anodes are fluidly connected to each other. The anode and cathode may be different sizes, as long as they are charge balanced.

A bi-directional pump 16 is provided in line with the cathodes and anodes. A startup battery 18 is provided for the pump 16. The pump 16 is provided so as to provide pressure for liquid electrolyte flow. The pump 16 can be a pump such as a gear pump or a peristaltic pump. Once the flow of a liquid electrolyte begins, power for the pump 16 may be supplied from the main power from the convection battery system 10 itself, and the startup battery 18 could be placed in a charging mode.

The flow of electrolyte fluid goes through the various components and also piping 20. The flow also travels through a plurality of dynamic separators 22 and dendrite-stopper chambers 24. These elements will be discussed in more detail below. Lithium ions travel with the electrolyte fluid, or bulk liquid, and preferably circulate in a counterclockwise direction, as shown in FIG. 1.

Electrons, however, travel in a clockwise direction opposite the liquid flow. In FIG. 1, it can be seen how the cathode 12a is electrically connected to the anode 14a. There are dendrite-stopper chambers 24 positioned on each side of the anode 14a. Electrical wiring 30 is connected between these dendrite-stopper chambers 24, the anode 14a and the cathode 12a. Additionally, as shown in FIG. 1, diodes 26 are connected to each of the dendrite-stopping chambers 24. The diodes 26 are arranged to only allow electrons to pass outwardly of the dendrite-stopper chambers 24.

As such, electrons travel from the anode 14a and dendrite-stopping chambers 22 on both sides of the anode 14a to the cathode 12a. The cathode 12a receives metal ions from the anode 14b via the liquid flow. This liquid flow is indicated by M+ in the drawing. FIG. 1 also illustrates the load 32 as being applied between the cathode 12a and the anode 14a.

As can be seen in FIG. 1, the various anodes and cathodes are connected via electrical wiring in an identical fashion. Metal ions and electrons reach all of these cathodes in the same manner as with cathode 12a. By flowing the metal ions and electrons in opposite directions, this system allows for greater electrical voltage buildup. For example, a Tesla automobile uses 450 volts. It takes 110 anodes and 110 cathodes connected in series, with metal ions and electrons traveling in opposite directions, to create 450 volts in the convection flow battery system of the present invention.

The electrodes of the present invention are fabricated to have minimal flow resistance but with large surface area for anode and cathode electrochemical reactions, as well as for charge transfer. These electrodes should have large porosity, and preferably the metal conductor should evenly be distributed in the electrode in 3D space, and allow for smooth liquid flow. In a preferred embodiment, the electrode utilized in the system of the present invention would be a microfibrous electrode. Three-dimensional microfibers media electrodes have enhanced mass and charge transport compared to traditional electrode structures, allowing electrochemical processes to be carried out at high current densities with enhanced energy efficiency.

Metal microfibrous electrodes have electrical conductivities at least on hundred times that of carbon-fiber-paper-based electrodes. This enhanced connectivity is realized in a three-dimensional structure, with enhanced contact between the electrochemically active phase in the sinter-welded charge carrier network.

Microfibrous media-based electrodes are highly porous, having void fractions that range from 62% to 98%. The openness of this structure enhances the diffusion of components to and from the electrode surface. The structure of these electrodes can be effective for liquid flow.

The metal fibers are preferably aligned lengthwise along the liquid flow path in the electrodes, to minimize the flow resistance.

Metal anodes, such as lithium metal anodes, can be packed with bare metal fibrous media without other material addition. Dendrite formation within the bare metal fibrous media in an anode is beneficial since it provides additional metal fibers and surface area for electrochemical reaction. Dendrite formation is only detrimental if it grows toward the cathode direction.

The cathode, and other types of anodes, may need to have additional layers of materials deposited or cemented on the metal fibers.

As can be seen in FIG. 1, the dendrite-stopping chambers 24 are positioned on each side of the anodes 14a and 14b. The dendrite-stopping chambers 24 are preferably chambers having bare-metal fibrous material media therein. The chambers of the dendrite stoppers 24 are smaller than the chambers of the anodes, but are structurally similar. These dendrite-stopping chambers 24, along with the connected diodes, are used to minimize dendrite formation. During the discharging process, as shown in FIG. 1, lithium metal from the anode will lose electrons to the cathode and become metal ions dissolved into the electrolyte solution. If there is any lithium metal in the dendrite-stopping chambers 24, it will dissolve and leave the dendrite stopper.

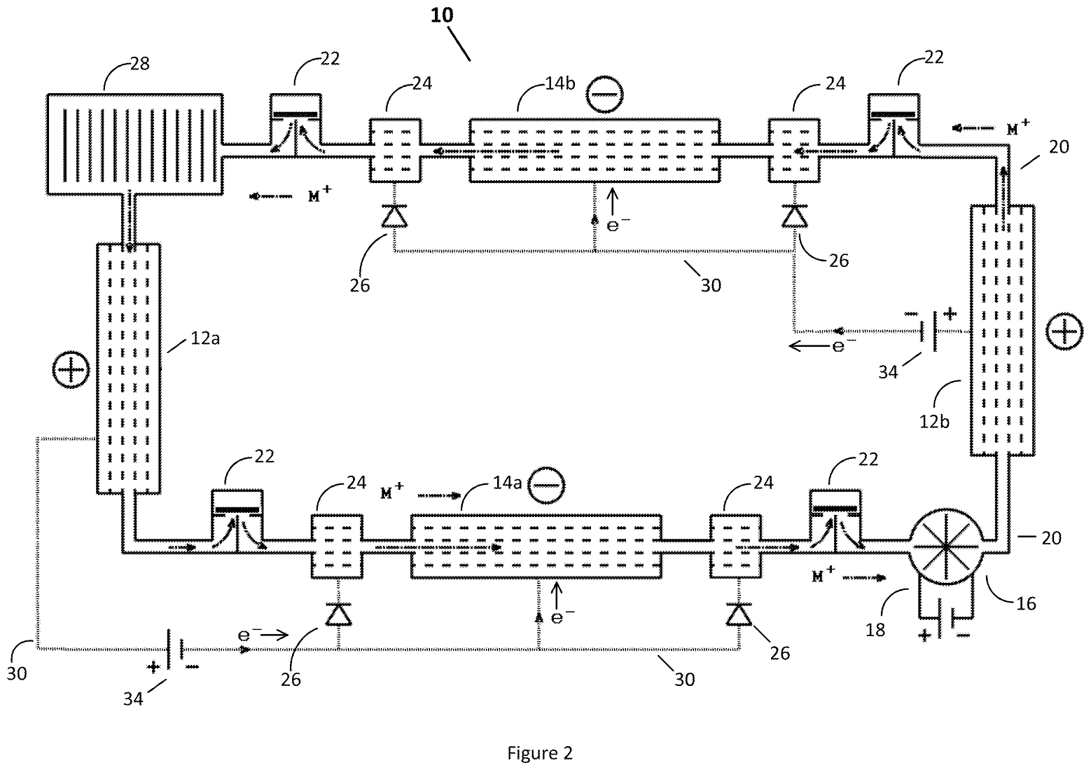

Referring to FIG. 2, there is shown the charging process of the convection battery system 10 in accordance with the program embodiment of the present invention. During the charging process, a charging power 34 is connected between the cathode 12a and the anode 14a. As such, electrons move into the anode 14a but not into the surrounding dendrite-stopping chambers 24 due to the presence of the diodes 26. The fluid flow of electrolyte is in the same direction as in FIG. 1 (i.e. counterclockwise). During the charging process, while electrons and metal ions are combining in the anodes forming pure metal, metal is not deposited in the dendrite-stopping chambers 24 because there are no free electrons therein. As noted above, electrons cannot flow into the dendrite-stopping chambers 24 because of the presence of the diodes 26, which only allow for electron flow in one direction (i.e. out of the dendrite-stopping chambers 24).

As such, if any metal dendrite debris breaks loose from an anode and ends up in the dendrite-stopping chambers 24, this metal will dissolve during the discharging process. The dendrite-stopping chambers 24 effectively act as guards on two sides of each of the anodes to prevent dendrites from extending beyond the dendrite-stopping chambers 24.

Preferably, the dendrite-stopping chambers 24 are packed more densely than the anodes, ideally to mimic fiber filters that can catch metal debris from the anodes. The dendrite-stopping chambers 24 can also catch stray electrons and prevent electrons from traveling to the cathode through the liquid electrolyte route.

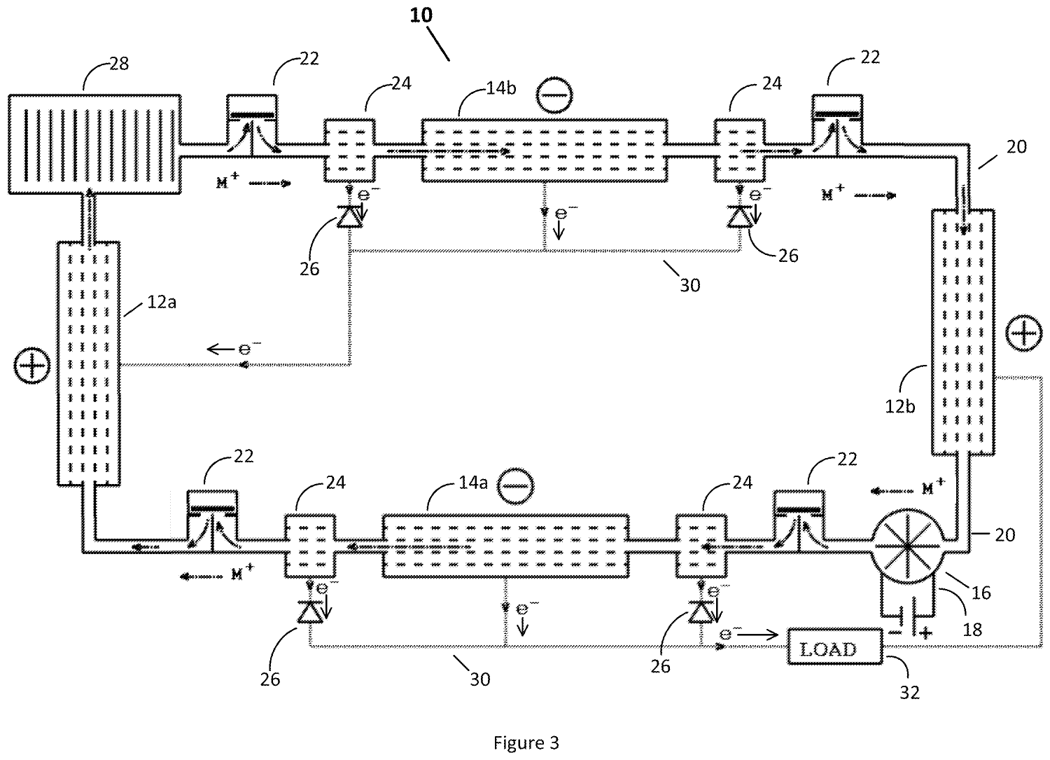

While the dendrite-stopping chambers of the present invention prevent dendrite growth, the present invention also provides a second way of preventing dendrite growth. Specifically, the liquid flow in the system can be reversed after some period of operation. For example, the liquid flow could be reversed after several weeks or months. FIG. 3 illustrates the discharging process of the battery system 10 when the flow is reversed. As can be seen in FIG. 3, in order to reverse the flow, it is necessary that the wiring between the cathodes and anodes be reversed or altered as well. Whereas in FIGS. 1 and 2, the cathodes 12a and the anode 14a were electrically connected, the anode 14a is now connected with the cathode 12b, whereas the cathode 12a is now connected to the anode 14b.

During the charging process as illustrated in FIG. 2, the dendrite grows on the left side of the anode 14a. When the flow is reversed, as in FIG. 3, the dendrite on the left side will dissolve during the discharging process and will grow on the right side of the anode 14a during the charging process. By altering the flow directions, the dendrite cannot grow to a significant scale and length.

Preferably, the electrodes of the system of the present invention have symmetric flow passages on both sides to eliminate differences in performance when the liquid flow is reversed.

In a preferred embodiment, the pump 16 is a bidirectional pump such as a gear pump or peristaltic pump, that is able to switch direction by flipping a switch. The pump motor can be controlled by a variable frequency drive to regulate the liquid flow and hence the electrical current.

The third safe guard for preventing dendrite damage in a convection battery is the distance between anodes and cathodes. Because of bulk flow for metal ion transport, the cathode and anode are no longer required to be near each other, further reducing the chance of short circuiting caused by dendrite formation.

In order to reduce fluid flow resistance, dynamic separators 22 are used. Separators are used in batteries to prevent the anode from touching the cathode, and to allow metal ions to pass through, but not electrons. Separators for conventional stationary batteries are microporous membranes.

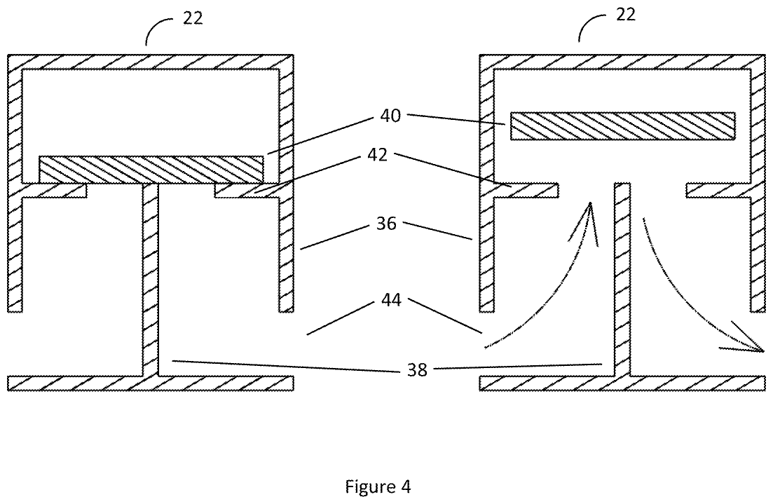

A dynamic separator 22 seals the liquid passageway between anode and cathode when there is no liquid flow, and opens up when there is liquid flow, as shown in FIG. 4. The body 36 of a separator with and without flow is shown. A partition wall 38 divides the fluid in an anode side and fluid in a cathode side. When there is no flow (as shown in the separator on the left side of FIG. 4), the separator plate 40 rests on the supporting tabs 42 and the partition wall 38 due to gravity, sealing the flow passageway 44. When flow starts (as shown in the separator on the right side of FIG. 4), the separator plate 40 is pushed up, allowing liquid flow through the flow passageway 44. The dynamic separator 22 allows flow from either directions, and is functional either in forward flow mode or reverse flow mode.

The separator plate 40 can be made of any solid electrical insulating material, such as rubber or plastics.

Other components may be added to the flow circuit at various locations. For example, as shown in FIGS. 1-3, a liquid cooler 28 is added at upper left corner. Other possible components include surge tanks to handle volume changes of the liquid and solid within the electrodes during charging and discharging, or bag filters to remove unwanted solid debris.

The convection battery system of the present invention can significantly increase individual cell size of a battery. Instead of thousands of battery cells in an electrical vehicle, a several hundred would be enough. A working battery system would consist of about 100-150 anodes and 100-150 cathodes in a single flow circuit, one or more pumps, and one or more radiator/coolers, with separators and dendrite-stoppering chambers in between anodes and cathodes.

By charge calculation, a liquid flow rate of 62.2 cc/min is able to generate a 20 amp current assuming the metal ion (M+) concentration in an anode is 0.2 M during a discharge cycle.

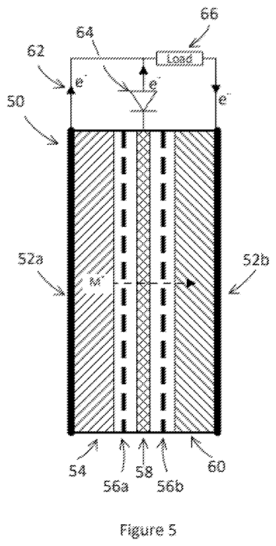

The above-mentioned dendrite-stopper method could also be used for traditional static batteries. As shown in FIG. 5, a battery 50 contains those components with a dentrite-stopper installed: a charge collector 52a on the anode side, a charge collector 52b on the cathode side, an anode 54, a porous membrane separator 56a on the anode side, a porous membrane separator 56b on the cathode side, a dendrite-stopper 58 in the middle between two separators, a cathode 60, a wiring connection 62, with the arrow of the line indicating electron flow direction during discharging operation, a diode 64 that is wired to the dendrite-stopper 58, which allows only outward electron flow, and a load 66.

The symbol e− indicating electron and the symbol M+ indicating metal ions.

During discharging operation, electrons flow from anode to cathode, active pure metal on the anode dissolves into electrolyte solution as metal ion M+. Metal ion M+ travels from anode toward cathode. Electrons also flow from dendrite-stopper through the diode 64, the electrical load 66 and outside wiring to reach the cathode, if there is active pure metal within the dendrite-stopper matrix. Active pure metal would turn into metal ions M+ and gives out electrons, and be removed from dendrite-stopper matrix.

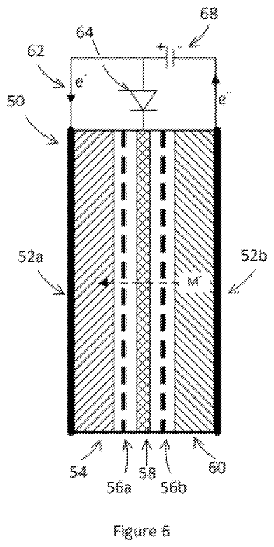

During the charging process as shown in FIG. 6, the electron and ion flow are reversed. Instead of load 66, a charging source 68 is used. Electrons flow into the anode and combine with metal ions to form active pure metal. Since the diode 64 prevents electrons from flowing into the dendrite-stopper, active pure metal cannot form there by combining with electrons from outside wiring.

There is a possibility that dendrites growing from the anode side could puncture the separator 56a, and touch the dendrite-stopper. If this happens, electrons can be supplied through anode dendrites and reach the dendrite-stopper.

Since the dendrite-stopper conducts electricity uniformly, the electrons that are supplied from the tips of dendrites will be uniformly distributed in the dendrite-stopper. The metal will deposit uniformly on the dendrite-stopper, instead of growing on the original dendrites.

No new dendrites can form until the dendrite-stopper is saturated with active metal. Properly designed dendrite-stoppers should be thick enough so that the discharging process should begin to dissolve all the active metal inside the dendrite-stopper before it is saturated with active metal.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

I claim:

1. A convection battery system comprising:
a plurality of anodes and cathodes in fluid connection, said plurality of cathodes and said plurality of anodes alternately arranged in a loop formation;
a pump positioned along the loop formation and adapted to flow electrolyte between the plurality of anodes and the plurality of cathodes;
a plurality of dendrite-stopping chambers in fluid communication with the plurality of anodes and the plurality of cathodes, the plurality of dendrite-stopping chambers having a bare metal fibrous media therein, each of the plurality of dendrite-stopping chambers having a diode connected thereto, the diode adapted to allow electrons to exit the dendrite-stopping chamber;
wherein said plurality of anodes and cathodes comprise:
a first cathode electrically connected to a first anode and to diodes of dendrite-stopping chambers positioned on each side of the first anode;
a second anode in fluid connection with the first cathode, and positioned on an opposite side of the first cathode from the first anode;
wherein, in a discharging process of the convection battery system, electrons move from the first anode toward the first cathode, and electrolyte is pumped and flows in a first direction, such that Li-ions move from the second anode to the first cathode.

2. The convection battery system of claim 1, further comprising a plurality of dynamic separators in fluid communication with the plurality of anodes and cathodes, each of said plurality of dynamic separators comprising a flow passageway and an electrically-insulating separator plate which closes the flow passageway when flow of electrolyte from the pump ceases.

3. A convection battery process comprising:
fluidly connecting a plurality of anodes and cathodes in an alternating loop arrangement;
flowing an electrolyte fluid in a first direction between the plurality of anodes and cathodes;
electrically connecting an anode and a cathode of the plurality of anodes and cathodes, wherein the cathode is upstream of the anode with regard to the first direction of the flow of electrolyte fluid;
applying a load to the system between the connected anode and cathode of the plurality of anodes and cathodes, such that electrons flow from the anode toward the cathode in a direction opposite the first direction of the flowed electrolyte fluid.

4. The convection battery process of claim 3, wherein an electrolyte flow direction and an electron flow direction can be reversed simultaneously, whereby alternating flow directions of electrolyte and electrons prevents dendrite formation and growth of a significant scale on either side of an anode of the plurality of anodes.

5. A static battery construction comprising:
a dendrite-stopping layer positioned between a first membrane separator and a second membrane separator;
an anode positioned exterior of said first membrane separator; and
a cathode positioned exterior of said second membrane separator;
wherein said dendrite stopping layer is connected via a wire to a diode which is adapted to only allows electrons to flow outwardly and toward the cathode during battery discharge;
wherein active metal and dendrites in the dendrite-stopping layer will dissolve during a discharge process; and
wherein active metal cannot grow during a charging process due to the diode not allowing electrons to flow into the dendrite-stopping layer.
